(19) United States
(12) Patent Application Publication
(10) Pub. No.: US 2014/0081493 A1
(43) Pub. Date: Mar. 20, 2014

(54) Modular instrumentation system for electric vehicle data acquisition, analysis and display, and component control

(71) Applicant: Electric Motor Werks, Inc., Palo Alto, CA (US)

(72) Inventors: Mikhail Shemyakin, San Jose, CA (US); Valery Miftakhov, San Mateo, CA (US); Henry Grishashvilli, San Jose, CA (US); Tim Bakhishev, Santa Clara, CA (US)

(21) Appl. No.: 13/681,399

(22) Filed: Nov. 19, 2012

Related U.S. Application Data
(60) Provisional application No. 61/561,832, filed on Nov. 19, 2011.

(51) Int. Cl. B60L 15/00

(52) U.S. Cl. CPC B60L 15/00
USPC 701/22

(57) ABSTRACT

Described is a Modular Instrumentation System for Electric Vehicle Data Acquisition, Analysis and Display, and Component Control. The system acquires data from and controls (where applicable) the multitude of devices that reside onboard and offboard of the electrical vehicle. For vehicles that have been converted from internal combustion (gasoline or diesel) engines to electric drive, this includes both the components installed as part of the conversion (such as electric motor, motor controller, battery pack and/or the battery management system, and charger), and the original components (such as speed sensor, distance traveled, braking and traction control systems—e.g. ABS and ETC, climate control, entertainment systems).

### BACKGROUND OF THE INVENTION

1. Field of the Invention

The present invention relates generally to electric vehicle technology and, more specifically, to electric vehicle conversion control and instrumentation system.

2. Description of the Related Art

The electric vehicle market is rapidly expanding around the world. A number of car manufacturers are slated to release one or more models of the full-electric or hybrid-electric cars in the next 2-3 years. However, the largest opportunity to electrify transportation in the US and worldwide is to convert the existing fleet of gasoline vehicles into electric propulsion. With the average 10-15 year lifetime of a gasoline car in the US, there are ˜250 million registered vehicles. Compared to total new vehicle sales of ˜15-20 million a year, this reflects much higher scale of the potential opportunity in conversions.

However, electric vehicle conversion market today suffers from a lack of OEM-grade solutions and components. In order to make electric conversions appealing to a large number of potential customers, several such components must be developed at the OEM quality and durability levels. One of the most critical components is a vehicle instrumentation and control system.

### SUMMARY OF THE INVENTION

The inventive methodology is directed to methods and systems that substantially obviate one or more of the above and other problems associated with conventional electric vehicle conversion control and instrumentation systems.

In accordance with one aspect of the invention, there is provided a modular instrumentation system for electric vehicle data acquisition, the system incorporating a data acquisition and control module communicatively coupled with plurality of electric vehicle components and a user interface device. In the inventive system, the data acquisition and control module is configured to acquire data from the multiple electric vehicle components and control the multiple electric vehicle components. The user interface device is configured to display the acquired data to the user and provide the user with a command interface for controlling the multiple electric vehicle components.

Further improvements include the modular instrumentation system for electric vehicle data acquisition further incorporating a communication module for establishing a data communication with a web portal.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of an inventive electric vehicle conversion control and instrumentation system.

FIG. 2 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one or more aspects of the invention, there is provided an innovative approach to designing an OEM-grade EV conversion control and instrumentation system (the System). The Invention described in detail below provides for seamless integration of all the key components (the Devices) in an electric conversion, while providing a much better driver experience compared to vast majority of the production cars on the market today. The modular nature of the inventive design allows application in a wide variety of conversion designs, with multiple different types and sources of components and vehicles.

In one or more embodiments, the inventive system comprises a Modular Instrumentation System for Electric Vehicle Data Acquisition, Analysis and Display, and Component Control.

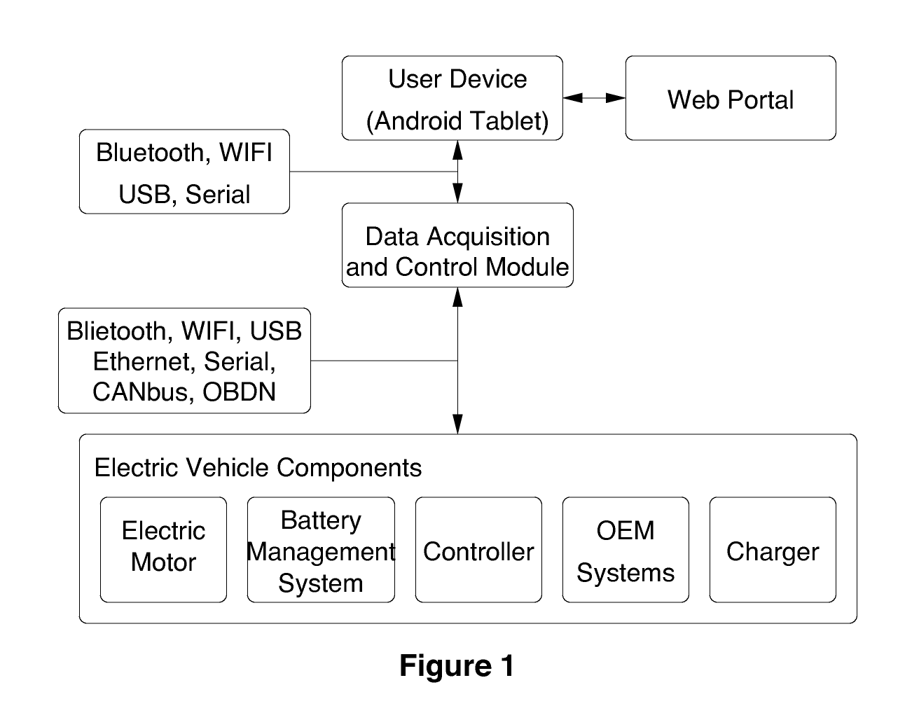

FIG. 1 provides a high level view of the components. The arrows are bidirectional to show both the data acquisition for analysis and display purposes, and the control signals sent to the equipment.

### Data Acquisition and Control Module

In one or more embodiments, the Data Acquisition and Control module (DACm) is the principal component of the System. The DACm collects data from the multitude of Devices and:
1. Aggregates the data to be sent to the User Interface module
2. Performs basic and advanced analysis on the data to
   1. Filter
   2. Summarize
   3. Interrelate various data sources
   4. Perform other basic processing
3. Send control signal to Devices based on the outcomes of real-time analysis
4. Receive configuration and control signals from the User Interface module. The targets of these signals may be the Data Acquisition and Control module itself, or the electric vehicle components.
5. Log data for future analysis/service.

In one or more embodiments, DACm is based on a popular open hardware Arduino platform. This approach dramatically decreases costs and increases parts availability. Specifically, Arduino Mega 2560 board is used as the main processing unit (MPU). With 256 KB of on-board flash, 16 MHz processor, and over 60 digital and analog inputs and outputs, one board is able to run all the control firmware and interface all the subsystems.

In one or more embodiments, for interface with Devices, a specialized add-on communication board (CommBoard) is used. The CommBoard has 2 main components: (1) sensor sub-system, and (2) data interface subsystem.

In one or more embodiments, the Sensor sub-system is designed to convert the most critical EV parameters into electrical signals compatible with the MPU. Such parameters include, but not limited to: motor current, motor voltage, motor temperature, battery current, battery voltage, battery temperature. In one or more embodiments, a very important feature of the sensor sub-system is full electrical isolation from the EV powertrain. This is critical for EMI noise immunity and reliability of DACm and is achieved through usage of the magnetic coupling devices (hall sensors) and non-conductive thermal sensors.

In one or more embodiments, the Data Interface subsystem is designed to connect to various Devices and User Interface module. As such, it contains a hardware and software-based realization of a number of data protocols. Specifically, the protocol list includes but not limited to: (1) CANbus protocol to connect to the host vehicle's main computer to access all vehicle's operating data (speed, distance traveled, etc.), (2) Bluetooth protocol for connection to the User Interface module, (3) Serial data protocol for connection to the offboard PC, (4) CAN-like proprietary protocol to communicate between electronic components (charger, controller, etc).

In one or more embodiments, the CAN-like protocol used by DACm is a redundant, failsafe, two-wire differential signaling protocol based on CAN physical communication layer. It features low-impedance differential signaling that is highly immune to EMI potentially present in EV installations. It realizes a much simplified version of the full CANbus protocol, resulting in a significant reduction of the communication overhead and better noise control and responsiveness. At a message level, the protocol features positive message confirmation and redundancy to make component state mismatch virtually impossible. Specifically, the protocol uses a double-acknowledgement approach: the received acknowledges the command replaying the command body back to the sender, the sender acknowledges the correct command receipt by the receiver, the receiver proceeds to perform the command ONLY when it receives sender's acknowledge. While introducing a small additional overhead into the communications, this approach makes it absolutely impossible for a component to execute an erroneous command.

In one or more embodiments, examples of the data analyses performed by the DACm include, without limitation:
1. Total output power based on the EV current and voltage sensors
2. Performance tuning based on state of the battery (e.g., measure temperature of the battery & voltage sag & state of charge and vary maximum allowed current to preserve battery life, etc)
3. MPGe calculation based on integration of data from the above-mentioned output power calculation and speed from an Android GPS or vehicle's CANbus
4. Range remaining in miles using predictive averaging algorithm based on the last X minutes of driving time, and the current measurement of the remaining pack capacity in AmpHours.

### Battery Management System

In one or more embodiments, the DACm gathers information from the Battery Management System (BMS), and provides both the individual cell measurements and the aggregated data to the User Interface module.

In one or more embodiments, the principal building block of the inventive BMS is the cell-level mini-module that performs the following functions:
1. Senses the cell's voltage
2. Senses the cell's temperature
3. Controls an opto-isolated analog normally closed loop, opening the loop when the cell's voltage or temperature go out of the operating envelope
4. Manages a serial interface to the head board, communicating cell's voltage and temperature on the head board's request. This interface may be implemented using an opto-isolated wired connection or a wireless connection using one of the short-range protocols such as Xbee.

In one or more embodiments, the analog outputs of the cell-level elements are then daisy-chained throughout each battery sub-pack, resulting in a sub-pack-level “Battery OK” signal. This signal is then routed from each sub-pack separately to the DACm.

Additionally, in one or more embodiments, each sub-pack contains an independent AH counter that runs a serial data wire to DACm.

As a result, the DACm monitors all sub-pack level BMS loops and reads out the AH status from each sub-board's chip. It then averages AH readings and uses that as a master AH counter. This approach dramatically reduces any errors due to slight differences in probe resistances, chip sensitivities, etc.

In one or more embodiments, the DACm will also use the sub-pack's chips to store sub-pack level battery event information (e.g., number of cycles, # of LowVoltageCutoff events, # of High-VoltageCutoff events, average/min/max currents, etc). This approach allows persistent battery information storage at the sub-pack level, in turn allowing effective management of the fleet of battery packs in an interchangeable way.

In one or more embodiments, overall, each sub-pack has 4 BMS connections: vehicle ground, +12V, analog loop (pulled up to 5V via a 1 k resistor), and a digital serial output/input. The other end of loop is connected internally to the vehicle ground. Ground and +12V pins are connected in parallel across all sub-packs, the remaining two pins are run individually to the DACm.

### OEM System Interfaces

In one or more embodiments, the DACm interfaces with a number of host vehicle's onboard systems. Specifically, it ties into the existing instrument cluster, allowing the gauges and other display devices to be re-used for EV readouts. For example, the tachometer can display the speed of the electric motor (in revolutions per minute), and the fuel gauge can display the state of charge (in percent amp-hours remaining).

Further, in one or more embodiments, the system integrates with the car's existing traction and stability control systems, by piggybacking on the throttle output of the host computer and re-using remaining existing sensors. This approach allows to keep all the existing traction control and stability control functionality present in the modern cars and dramatically reduces the required complexity of the EV conversion and increases the quality of drive.

Where possible, the inventive system uses CANbus protocol for inter-component communication.

### User Interface Module

In one or more embodiments, the User Interface module displays real-time information to the driver and takes control inputs. Information displayed includes, without limitation:
1. Individual data points (sensor signal) shown in gauge form. Including but not limited to:
   1. Speed
   2. Voltage
   3. Current
   4. Charge remaining
   5. Fuel percentage remaining
   6. Motor temperature
   7. Battery pack temperature
2. Calculated data points. Including but not limited to:
   1. Travel distance (range) remaining
   2. Average fuel economy, in MPGe or WH/mile
   3. Efficiency relative to past performance, fleet average, etc.
   4. Money saved versus driving a gasoline or diesel car (current trip, today, this week, to date).

In one or more embodiments, the user interface displays several screens, including, without limitation:
1. Real-time driver display showing key performance metrics
2. An in-depth detailed display showing pack voltage, individual cell voltage, and other technical details
3. Configuration screen to modify electric car components' settings and configuration
4. Navigation screen for routing, directions, POI search, charging stations etc. Including a list of nearby public free and paid charging stations
5. Entertainment screen for media (music, video)
6. Climate control screen for controlling the vehicles heating and air conditioning.

In one or more embodiments, the User Interface module has the capability to display a warning to the user when it deems that the remaining charge is insufficient to reach the destination. Upon such notification, or an explicit user request, the nearest known charging stations can be shown based on a database of public charging stations as well as a user-input list of private charging stations (own home, friend/relative homes, workplace, etc). The charging stations shown are then color coded with respect to the remaining range in the battery pack (i.e. green for stations within 50% of the remaining range, yellow within 50-75%, red within 75-100%, and light gray for out-of-range).

In one or more embodiments, the User Interface module can be removed from the vehicle and used to monitor and configure vehicle systems remotely while away from the vehicle, but in range of the wireless connection. The module can be used to remotely manipulate the climate control system of the vehicle, as well as control the charger operation. It can be used to start, stop, or control the rate of charging. It can further be used to schedule charging patterns, for example to take advantage of Time of Use (TOU) pricing offered by a Utility company. If the Electric Utility company operating the grid to which the vehicle is connected for charging supports Demand Response (DR) programs, the system can receive real-time DR signals from the Utility and control the charger accordingly.

In one or more embodiments, the User Interface module has the capability to perform analytics on the collected data and:
1. Automatically modify the configuration of the Data Acquisition and Control module, and the Individual vehicle components to improve vehicle performance
2. Display recommendations to the driver on how to achieve better efficiency, better performance (e.g. acceleration), maximize component longevity (e.g. when driving in harsh conditions such as extreme heat or cold), etc.

Additional examples of innovative UI design:
1. The fuel economy gauge is designed to promote efficient driving. The gauge dial is color coded with yellow and red denoting low fuel economy. According to a multitude of psychological studies, when people are presented with such readouts, they instinctively strive to ‘stay in the green’. The resulting effect is not only beneficial to the environment/grid/etc., but also is very impactful on the practical range of the EV and therefore perceived driver experience
2. $ value of the gasoline NOT burned by driving an EV instead. Again, psychological studies indicate that people respond very strongly to direct monetary stimulus and immediate gratification. By exposing the real-time readout of the monetary impact of driving the EV, this design provides continuous instant gratification to the driver, dramatically increasing satisfaction from the EV ownership.

### Interfaces for External Connectivity and Instrumentation System as Platform

In one or more embodiments, the inventive Instrumentation System is designed from the ground up to work as both a finished, usable product, and as an open, extensible platform, upon which new application and enhancements can be built.

In one or more embodiments, the User Interface module provides connectivity to other applications and systems, including generic or third party applications and systems. This is accomplished through a standard, published, Application Programming Protocol (API). The API allows the system to be extensible, and will enable end users and other vendors to build new functionality for the system.

Additionally, in one or more embodiments, the system allows new configurations to be created and used by third parties. This is accomplished through an open configuration specification, and gives end users and vendors an opportunity to tune the electric vehicle as a whole and its individual components to their liking, further innovating on the inventive platform.

### Web Portal

In one or more embodiments, the User Interface module has the capability to log the collected data and periodically send it to the inventive Web Portal. The UI module further is capable of publishing information to third-party internet sites. For example, social networking sites such as Facebook and Twitter, e.g. posts sharing how much money the driver saved over the course of the week by driving electric.

In one or more embodiments, the User Interface module can receive information from the inventive Web Portal. This information can be used to
1. Modify the configuration of the
   1. UI module
   2. Data Acquisition and Control module
   3. Electric vehicle components
2. Notify driver of updates and news from the manufacturer of the conversion;
3. Notify driver of any performance, maintenance or safety issue with their specific vehicle based on the data collected from their vehicle.

In one or more embodiments, the inventive Web Portal can perform further analysis of the data, both on individual vehicles and in aggregate of a multitude of the converted vehicles. The latter allows analysis of averages, detection of common issues, early prediction of faults, etc.

In one or more embodiments, the inventive Web Portal can be used by the customer (driver) to remotely monitor their vehicle, both real-time and historically. The inventive Web Portal stores the historical data, and provides an itneractive web-based interface to the user to view past operational performance—miles driven, average efficiency, charging history, etc.

In one or more embodiments, the inventive Web Portal shows real-time information, including state of charge, e.g. allowing the driver to monitor the vehicle charging while away from it, such as at home or in the office while the vehicle is in the garage or parking lot.

### Security

In one or more embodiments, the instrumentation system provides a number of security features to provide convenience, safety and security. Ignition can be controlled remotely from the User Interface module or from the inventive Web Portal, but is password protected to prevent unauthorized access. This can be used both to remotely turn on the car, as well as to remotely disable it in case of theft or unauthorized entry. Two-factor authentication can be available to the user based on their preferences.

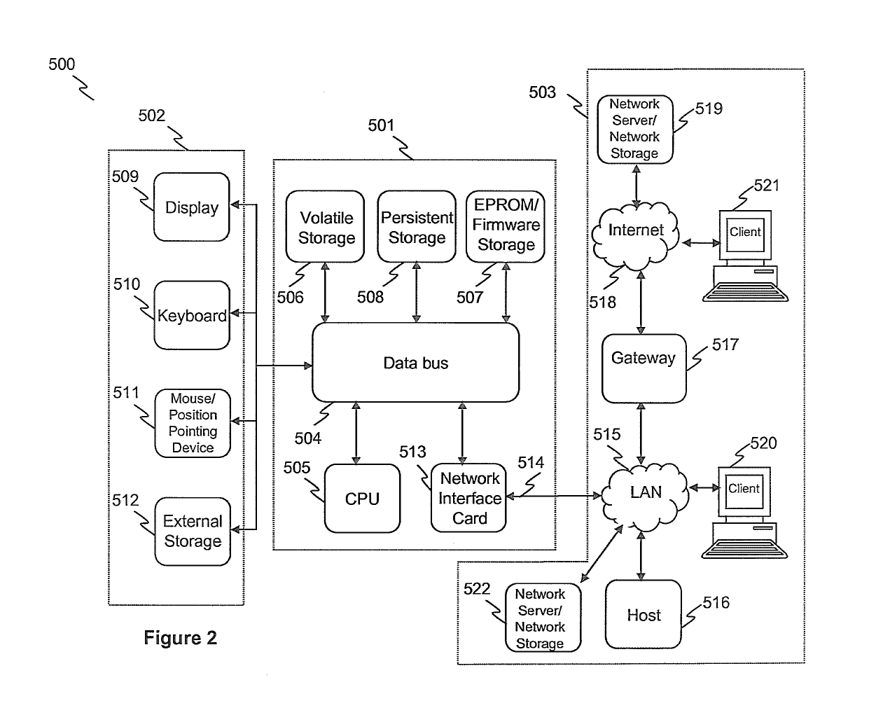

FIG. 2 illustrates an exemplary embodiment of a computer platform upon which the inventive system may be implemented.

FIG. 2 is a block diagram that illustrates an embodiment of a computer/server system 500 upon which an embodiment of the inventive methodology may be implemented. The system 500 includes a computer/server platform 501, peripheral devices 502 and network resources 503.

The computer platform 501 may include a data bus 505 or other communication mechanism for communicating information across and among various parts of the computer platform 501, and a processor 505 coupled with bus 501 for processing information and performing other computational and control tasks. Computer platform 501 also includes a volatile storage 506, such as a random access memory (RAM) or other dynamic storage device, coupled to bus 505 for storing various information as well as instructions to be executed by processor 505. The volatile storage 506 also may be used for storing temporary variables or other intermediate information during execution of instructions by processor 505. Computer platform 501 may further include a read only memory (ROM or EPROM) 507 or other static storage device coupled to bus 505 for storing static information and instructions for processor 505, such as basic input-output system (BIOS), as well as various system configuration parameters. A persistent storage device 508, such as a magnetic disk, optical disk, or solid-state flash memory device is provided and coupled to bus 501 for storing information and instructions.

Computer platform 501 may be coupled via bus 505 to a display 509, such as a cathode ray tube (CRT), plasma display, or a liquid crystal display (LCD), for displaying information to a system administrator or user of the computer platform 501. An input device 510, including alphanumeric and other keys, is coupled to bus 501 for communicating information and command selections to processor 505. Another type of user input device is cursor control device 511, such as a mouse, a trackball, or cursor direction keys for communicating direction information and command selections to processor 505 and for controlling cursor movement on display 509. This input device typically has two degrees of freedom in two axes, a first axis (e.g., x) and a second axis (e.g., y), that allows the device to specify positions in a plane.

An external storage device 512 may be coupled to the computer platform 501 via bus 505 to provide an extra or removable storage capacity for the computer platform 501. In an embodiment of the computer system 500, the external removable storage device 512 may be used to facilitate exchange of data with other computer systems.

The invention is related to the use of computer system 500 for implementing the techniques described herein. In an embodiment, the inventive system may reside on a machine such as computer platform 501. According to one embodiment of the invention, the techniques described herein are performed by computer system 500 in response to processor 505 executing one or more sequences of one or more instructions contained in the volatile memory 506. Such instructions may be read into volatile memory 506 from another computer-readable medium, such as persistent storage device 508. Execution of the sequences of instructions contained in the volatile memory 506 causes processor 505 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 505 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 508. Volatile media includes dynamic memory, such as volatile storage 506.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 505 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 505. The bus 505 carries the data to the volatile storage 506, from which processor 505 retrieves and executes the instructions. The instructions received by the volatile memory 506 may optionally be stored on persistent storage device 508 either before or after execution by processor 505. The instructions may also be downloaded into the computer platform 501 via Internet using a variety of network data communication protocols well known in the art.

The computer platform 501 also includes a communication interface, such as network interface card 513 coupled to the data bus 505. Communication interface 513 provides a two-way data communication coupling to a network link 515 that is coupled to a local network 515. For example, communication interface 513 may be an integrated services digital network (ISDN) card or a modem to provide a data communication connection to a corresponding type of telephone line. As another example, communication interface 513 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 513 sends and receives electrical, electromagnetic or optical signals that carry digital data streams representing various types of information.

Network link 513 typically provides data communication through one or more networks to other network resources. For example, network link 515 may provide a connection through local network 515 to a host computer 516, or a network storage/server 517. Additionally or alternatively, the network link 513 may connect through gateway/firewall 517 to the wide-area or global network 518, such as an Internet. Thus, the computer platform 501 can access network resources located anywhere on the Internet 518, such as a remote network storage/server 519. On the other hand, the computer platform 501 may also be accessed by clients located anywhere on the local area network 515 and/or the Internet 518. The network clients 520 and 521 may themselves be implemented based on the computer platform similar to the platform 501.

Local network 515 and the Internet 518 both use electrical, electromagnetic or optical signals that carry digital data streams. The signals through the various networks and the signals on network link 515 and through communication interface 513, which carry the digital data to and from computer platform 501, are exemplary forms of carrier waves transporting the information.

Computer platform 501 can send messages and receive data, including program code, through the variety of network(s) including Internet 518 and LAN 515, network link 515 and communication interface 513. In the Internet example, when the system 501 acts as a network server, it might transmit a requested code or data for an application program running on client(s) 520 and/or 521 through Internet 518, gateway/firewall 517, local area network 515 and communication interface 513. Similarly, it may receive code from other network resources.

The received code may be executed by processor 505 as it is received, and/or stored in persistent or volatile storage devices 508 and 506, respectively, or other non-volatile storage for later execution.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, pert, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in electric vehicle conversion control and instrumentation systems. It is intended that the specification and examples be considered as exemplary only, with a true scope and spirit of the invention being indicated by the following claims.

What is claimed is:

1. A modular instrumentation system for electric vehicle data acquisition, the system comprising a data acquisition and control module communicatively coupled with plurality of electric vehicle components and a user interface device, wherein the data acquisition and control module is configured to acquire data from the plurality of electric vehicle components and control the plurality of electric vehicle components; and wherein the user interface device is configured to display the acquired data to the user and provide the user with a command interface for controlling the plurality of electric vehicle components.

2. The modular instrumentation system for electric vehicle data acquisition of claim 1, further comprising a communication module for establishing a data communication with a web portal.
